(19) United States
(12) Patent Application Publication
(10) Pub. No.: US 2010/0129493 A1
(43) Pub. Date: May 27, 2010

(54) Low Sugar Yoghurt

(76) Inventors: Jeroen Monster, Wormerveer (NL); Ulrike Schmid, Wormerveer (NL); Ellen Maria Elizabeth Mulder, Wormerveer (NL)

Correspondence Address: MORGAN LEWIS & BOCKIUS LLP, 1111 PENNSYLVANIA AVENUE NW, WASHINGTON, DC, 20004, US

(21) Appl. No.: 12/597,284

(22) PCT Filed: Apr. 23, 2008
(86) PCT No.: PCT/EP08/03268

§ 371 Date: Dec. 14, 2009

(30) Foreign Application Priority Data
Apr. 24, 2007 (EP) 07251709.7

(51) Int. Cl. A23C 21/02; A23L 1/236; A23C 9/13

(52) U.S. Cl. 426/41; 426/548; 426/583

(57) ABSTRACT

A yoghurt comprises: a fat phase comprising conjugated linoleic acid or a derivative thereof (CLA); fruit; and sugar in an amount of less than 7.5% per weight. Preferably, the yoghurt has an energy content of less than 100 kcal/100 g.

This invention relates to a yoghurt and to a process for its production.

Yoghurt (sometimes termed yoghurt, or less commonly yoghourt or yogourt) is a dairy product produced by bacterial fermentation of milk. Fermentation of the milk sugar (lactose) produces lactic acid, which acts on milk protein to give yoghurt its gel-like texture and its characteristic tang. Natural, unflavored yoghurt is common; fruit, vanilla, and chocolate flavours are also popular. Yoghurts and methods for their production are described in, for example, WO 02/090527, EP-A-1749446, US20060210668 and EP-A-1749447.

The nutritional value of the diet has come under increasing scrutiny. Food supplements are often taken by individuals in order to obtain nutritional benefits. However, food supplements are typically in the form of capsules or the like and have the disadvantage that they are inconvenient in that individual has to remember to take them. Food supplements of this type are typically not flavoured and are not attractive to many consumers.

Nutritional supplements have been incorporated into food products but the resulting food products can have an undesirable taste and the incorporation of the supplement can have a deleterious effect on the stability of the products.

Conjugated linoleic acid (CLA) is a conjugated dienoic fatty acid having 18 carbon atoms. As a result of the presence of the two double bonds in CLA, geometrical isomerism is possible and the CLA molecule or moiety may exist in a number of isomeric forms. The cis9, trans 11 (“c9t11”) and trans10, cis12 (“t10c12”) isomers of CLA are generally the most abundant and beneficial pharmacological effects have been identified for each of these isomers.

U.S. Pat. No. 6,468,556 discloses the administration of CLA for inhibiting liver fat accumulation. However, this document is not concerned with the stability of its formulations or whether they have an acceptable taste and texture.

U.S. Pat. No. 7,115,759 and U.S. Pat. No. 6,608,222 disclose the production of CLA and its incorporation into various prepared food products. Neither document is concerned with solving the problems that occur when CLA is formulated into a food product or how these might be overcome.

US 2006/0159824 discloses yoghurt compositions containing CLA and a relatively high amount of added sugar, which is taught as being necessary to improve the taste quality of the product. Thus, the yoghurts of this document have a relatively high calorie content. In Example 1, a vanilla syrup (having a high sugar content) is added to the product, in addition to sugar.

US 2007/0031536 relates to certain fermented foods but not yoghurts. In Example 6, for instance, the ingredients of the fermented food include only 8% milk and over 60% water.

WO 00/21379 relates to food substances based on substances derived from milk, which contain isomers of CLA.

EP-A-1618800 relates to compositions containing extracts of tomatoes. CLA may be included in the tomato extract.

There remains a need for food products containing CLA that can have a low energy content (i.e., are low calorie) but still have good organoleptic properties such as taste and mouthfeel. We have now found certain compositions that solve these problems.

Accordingly, the present invention provides a yoghurt comprising: a fat phase comprising conjugated linoleic acid or a derivative thereof (CLA); fruit; and sugar in an amount of less than 7.5% per weight.

The invention also provides a yoghurt comprising: a fat phase comprising conjugated linoleic acid or a derivative thereof (CLA); and fruit, wherein the yoghurt has an energy content of less than 100 kcal/100 g.

In another aspect, the invention provides a process for producing the yoghurt of the invention, which comprises:
(a) forming an emulsion of conjugated linoleic acid or a derivative thereof (CLA) in milk;
(b) forming a mixture of milk powder, whey protein and optionally sugar with milk;
(c) combining the emulsion of (a) with the mixture of (b);
(d) optionally pasteurising the product of (c); and
(e) fermenting the optionally pasteurised product of (c) in the presence of a starter culture.

A further aspect of the invention is the use of a yoghurt according to the invention for a nutritional benefit. A preferred benefit is body weight management, in particular a reduced tendency to fluctuation of body weight.

In the invention, the CLA and the sugar combine to give a yoghurt having a number of advantages. The sugar can be kept at relatively low levels, even in the presence of fruit. Thus, yoghurts of the invention may have good mouthfeel. For example, they may be smooth, have an acceptable hardness, be non-chalky, non-watery, non-sandy, and have a creamy texture. They may have a long shelf-life, with texture, appearance and colour remaining good. The yoghurts may have little or no phase separation or sedimentation, little tendency to whey off and have a good flavour which is fruity and balanced, with little or no beany off-flavours.

Yoghurts of the invention comprise conjugated linoleic acid or a derivative thereof (CLA) and contain sugar (i.e., sucrose), wherein the sugar content is less than 7.5% per weight. The sugar content may be at least 0.1% by weight but can be lower. The sugar content is preferably less than 5% by weight, more preferably less than 3% by weight, such as less than 2% by weight. Preferably, the sugar content ranges from 0.5 to 5% by weight, more preferably from 2 to 4.5% by weight. Typically, the sugar is added as sucrose to the formulation prior to fermentation to form the yoghurt.

The yoghurt preferably comprises less than 2% by weight dairy fat, more preferably less than 1% by weight dairy fat, even more preferably less than 0.5% by weight dairy fat, such as less than 0.1% by weight dairy fat. Dairy fat will typically be included in the composition as part of another component, such as milk or a milk product.

The overall fat content of the yoghurt is preferably less than 5% by weight, more preferably from 0.5% to 4% by weight, such as from 1% to 3% by weight.

Optionally, the yoghurt may comprise a flavouring substance. Flavouring substances may be used singly or in combination and include natural and artificial flavouring agents.

In one embodiment, the yoghurt has a low total sugar content. Typically, the yoghurt may comprise less than 10% by weight of total sucrose, glucose and fructose, preferably less than 5% by weight, most preferably from 1 to 4.5% by weight. Sucrose, glucose and fructose may be specifically added or may be present as part of another component of the yoghurt.

The yoghurt may comprise a sugar replacer and/or a sweetener. Examples of suitable sweeteners are saccharin, aspartame, sucralose, neotame and acesulfame potassium, acesulfame, taumatine, cyclamate, and mixtures thereof. Preferred sweeteners are those selected from aspartame, acesulfame, sucralose and mixtures thereof. Sugar replacers include, for example, sorbitol, mannitol, isomaltitol, xylitol, isomalt, lactitol, hydrogenated starch hydrolysates (HSH, including maltitol syrups) and mixtures thereof.

The yoghurt may contain non-fat milk solids in an amount of from 5 to 20% by weight, preferably from 11 to 18% by weight. Non-fat milk solids may be specifically added or may be present as part of another component of the yoghurt. Typically, the non-fat milk solids will be derived from milk or products derived from milk, such as skimmed milk, skimmed milk powder and whey protein powder.

The yoghurt may comprise fruit and may be classed as a fruit yoghurt. For example, the yoghurt may comprise fruit in an amount of at least 1% by weight, or from 2 to 10% by weight, more preferably from 3.5 to 8% by weight on a wet basis. Wet basis refers to the fruit material including any water associated with it, for example 20% by weight added apple juice corresponds to 20% by weight fruit on a wet basis. The fruit is typically admixed with the yoghurt. Examples of suitable fruits are orange, banana, pineapple, mango, passion fruit, coconut, blackberry, blueberry, apple, strawberry, cranberry, lemon, lime and mixtures thereof. Other suitable fruits can be derived from, for example, pear, peach, plum, apricot, nectarine, grape, cherry, currant, raspberry, gooseberry, elderberry, blueberry, grapefruit, mandarin, grapefruit, mango, guava, rhubarb, pomegranate, kiwi, papaya, watermelon, passion fruit, tangerine, and cantaloupe. The fruits can be in the form of juices, concentrates, particles and, preferably, purées.

Optionally, the yoghurt comprises from 0.05 to 0.8% by weight of a thickener (i.e., a thickening agent). Suitable thickening agents include gum acacia, natural starch, modified food starches (e.g., alkenylsuccinate modified food starches), anionic polymers derived from cellulose (e.g. carboxymethylcellulose), gum ghatti, modified gum ghatti, xanthan gum, tragacanth gum, guar gum, locust bean gum, pectin, gelatine, carrageenan and mixtures thereof.

The yoghurt typically has a casein:whey weight ratio of >2, preferably from 2.5 to 3.5.

The yoghurt may additionally comprise a source of dietary fibre. Dietary fibres are complex carbohydrates resistant to digestion by mammalian enzymes, such as the carbohydrates found in plant cell walls and seaweed, and those produced by microbial fermentation.

Yoghurts of the invention optionally comprise one or more additional additives selected from colouring agents, vitamins, minerals, acidity regulators, preservatives, emulsifiers, antioxidants and mixtures thereof. Each of these materials may be a single component or a mixture of two or more components.

Examples of suitable vitamins and minerals include calcium, iron, zinc, copper, phosphorous, biotin, folic acid, pantothenic acid, iodine, vitamin A, vitamin C, vitamin B1, vitamin B2, vitamin B3, vitamin B6, vitamin B9, vitamin B12, vitamin D, vitamin E, and vitamin K. Preferably, when a vitamin or mineral is utilized the vitamin or mineral is selected from iron, zinc, folic acid, iodine, vitamin A, vitamin C, vitamin Be, vitamin B3, vitamin B6, vitamin B12, vitamin D, and vitamin E.

Acidity regulators include organic as well as inorganic edible acids. The acids can be added or be present in their undissociated form or, alternatively, as their respective salts, for example, potassium or sodium hydrogen phosphate, potassium or sodium dihydrogen phosphate salts. The preferred acids are edible organic acids which include citric acid, malic acid, fumaric acid, adipic acid, phosphoric acid, gluconic acid, tartaric acid, ascorbic acid, acetic acid, phosphoric acid, or mixtures thereof. Glucono Delta Lactone (GDL) may also be used, particularly wherein it is desired to reduce pH without introducing excessive acidic, or tart, flavour in the final composition. Citric acid is particularly useful.

Colouring agents including natural and artificial colours may optionally be used. Non-limiting examples of colouring agents include colours present in vegetable juices, riboflavin, carotenoids (e.g. n-carotene), tumeric, and lycopenes. However, the yoghurt of the invention may be free of extracts from tomato.

Preservatives may be selected from the group consisting of sorbate preservatives, benzoate preservatives, and mixtures thereof.

Antioxidants include, for example, natural or synthetic tocopherols, TBHQ, BHT, BHA, free radical scavengers, propylgallate, ascorbylesters of fatty acids and enzymes with anti-oxidant properties.

The yoghurt of the invention is preferably derived from milk products of which at least 80% by weight are from dairy sources (i.e., from cow's milk), more preferably at least 90% by weight, such as at least 95% or at least 99% by weight. Preferably, the yoghurt is free of other non-dairy milks such as soy milk.

The yoghurt of the invention is derived from milk or milk products and is typically derived from ingredients including at least 51%, preferably at least 60%, more preferably at least 70%, even more preferably at least 80%, by weight milk or milk products, based on the weight of the yoghurt.

The yoghurt may contain bacteria, which may be live. Alternatively, the yoghurt may have been pasteurised. Yoghurt bacteria cultures are mostly species from Streptoccus and Lactobacillus. Preferred are the bacteria Streptococcus salivarius subsp. thermophilus, Streptococcus filant, Streptococcus lactis var. taette, Streptococcus lactis subsp. diacetylactis and Lactobacillus delbrueckii subsp. bulgaricus. The yoghurt may comprise other lactic acid bacteria for taste or health effects (probiotics). These include, for example, Lactobacillus sp, such as L. acidophilus and Lactobacillus casei and Bifidobacterium species.

The fat phase in the yoghurt of the invention preferably comprises conjugated linoleic acid (CLA) or a derivative thereof in an amount of at least 20% by weight, more preferably at least 30% by weight, even more preferably at least 40% by weight, such as at least 50% by weight, for example at least 60%, at least 70%, at least 80% or at least 90% by weight of the fat phase. The upper limit of CLA in the fat phase may be 95% or 100% by weight. The amount of CLA in the fat phase is based on the total weight of fatty acids in the fat (calculated as free fatty acid). The term “CLA”, as used herein refers to conjugated linoleic acid and its derivatives. The CLA may be used in the form of the free acid. Derivatives of conjugated fatty acids include salts and esters thereof, or a mixture of two or more of these materials. Salts are non-toxic, pharmaceutically acceptable and/or acceptable for use in food products and/or pharmaceuticals and include, for example, salts with alkali metals and alkaline earth metals such as sodium, calcium and magnesium, preferably sodium. Esters include, for example, mono-, di- and tri-glycerides and mixtures thereof, and C₁ to C₆ alkyl esters (where the alkyl group can be straight chain or branched), as well as esters formed with alcohols that are acceptable in food products or pharmaceutical products, such as are disclosed in EP-A-1167340, the contents of which are incorporated by reference herein. Suitable alcohols include terpene alcohols or sesquiterpene alcohols, for example menthol, isopulegol, menthenol, carveol, carvomenthenol, carvomenthol, isobornylalcohol, caryophyllenealcohol, geraniol, farnesol and citronellol.

The preferred form of CLA for use in the invention is as a glyceride. Particularly preferred are diglycerides and triglycerides, with triglycerides being even more preferred.

The CLA may comprise one isomer or a mixture of two or more different isomers including: cis, cis; cis, trans; trans, cis; and trans, trans isomers. Preferred isomers are the trans10, cis12 and cis9, trans 11 isomers (also referred to herein as t10e12 and c9t11, respectively), including these isomers in relatively pure form, as well as mixtures with each other and/or mixtures with other isomers. Typically, the fat phase of the yoghurt will comprise at least 20% by weight of the c9t11 isomer and/or at least 20% by weight of the t10c12 isomer. More preferably, the conjugated linoleic acid or derivative thereof comprises trans10, cis12 and cis9, trans11 isomers and the weight ratio of trans10, cis12 isomer to cis9, trans11 isomer or vice versa is at least 1.2:1, such as 1.3:1, even more preferably at least 1.5:1, e.g., in the range 1.5:1 to 100:1 or 1.5:1 to 10:1, such as a 60:40 or 80:20 mixture of the trans10, cis12: cis9, trans 11 isomers. Particularly preferred are compositions comprising the trans10, c is 12 isomer or the cis9, trans 11 isomer as the major isomer component i.e., present in an amount of at least 55%, preferably at least 60%, more preferably at least 70%, even more preferably at least 75%, most preferably at least 80%, such as at least 90% or even 100% by weight based on the total amount of conjugated linoleic acid. For example, the CLA may comprise c9t11 and t10c12 isomers and the weight ratio of the c9t11 to t10c12 isomers may be from 99:1 to 1 to 99, preferably from 90:10 to 10:90 most preferably from 80:20 to 20:80.

CLA can be produced in conventional ways. For example, CLA can be produced by known methods, such as that described in EP-A-902082, the contents of which are incorporated herein by reference. CLA products that are enriched in one or more isomers are disclosed in WO 97/18320, the contents of which are also incorporated herein by reference.

Examples of other fatty acids that may be present in the fat phase of the yoghurt include linoleic acid, oleic acid, taxoleic, juniperonic, sciadonic, saturated fatty acids, pinolenic acid, EPA (eicosapentaenoic) and DHA (docosahexaenoic). These other fatty acids may be present as free acids or derivatives in the same way as CLA and are preferably present as glycerides, more preferably triglycerides.

The CLA is optionally blended with additional fatty acids or glycerides before being used in the fat of the present invention. When the compositions contain one or more fatty acids and/or glycerides in addition to the CLA, the additional fatty acid(s) and/or glycerides are preferably selected from liquid oils, such as soybean oil, sunflower oil, rape seed oil and cotton seed oil; cocoa butter and cocoa butter equivalents; palm oil and fractions thereof; enzymically made fats; pine nut oil; fish oils and fractions thereof; gamma linolenic acid and enriched mixtures thereof; hardened liquid oils; and mixtures thereof.

The CLA can be included in the yoghurt of the invention as an oil or in the form of a powder, such as a free flowing powder. CLA and its derivatives in powder form can be produced, for example, by spray drying CLA, or a fat comprising CLA, with protein and/or carbohydrate, with the powder typically comprising from 50 to 90% by weight of fat. A preferred powder comprises 70 to 90% by weight triglyceride of which at least 70% by weight is CLA. It has been found that use of the powder can give extra stability to the yoghurt.

Preferably, the yoghurt of the invention is a low calorie product. For example, the yoghurt may have an energy content of less than 100 kcal/100 g, more preferably less than 80 kcal/100 g, even more preferably from 55 to 75 kcal/100 g. Calorie contents can be determined by methods well known to those skilled in the art, for example, as set out in Mullan, 2006, Labelling Determination of the Energy Content of Food: http://www.dairyscience.info/energy_label.asp#3 and/or FAO Food And Nutrition Paper 77, Food energy—methods of analysis and conversion factors, Report of a Technical Workshop, Rome, 3-6 Dec. 2002, Food And Agriculture Organization of the United Nations, Rome, 2003, ISBN 92-5-105014-7.

In another aspect, the invention provides a process for producing the yoghurt of the invention. The process comprises:
(a) forming an emulsion of conjugated linoleic acid or a derivative thereof (CLA) in milk (for example a 10% by weight emulsion in milk);
(b) forming a mixture of milk powder (preferably skimmed milk powder), whey protein and optionally sugar, with milk;
(c) combining the emulsion of (a) with the mixture of (b);
(d) optionally pasteurising the product of (c) for example by heating for up to 5 minutes at greater than 90° C.; and
(e) fermenting the optionally pasteurised product of (c) in the presence of a starter culture (for example at 30 to 34° C. at pH 4 to 5).

Preferably, the resulting yoghurt is then cooled and further optional additives such as sugar syrup and/or fruit are added. The yoghurt may then be packaged, for example by filling in pots or other suitable containers and is typically cooled to below 5° C. and stored.

The listing or discussion of an apparently prior-published document in this specification should not necessarily be taken as an acknowledgement that the document is part of the state of the art or is common general knowledge.

The following non-limiting examples illustrate the invention and do not limit its scope in any way. In the examples and throughout this specification, all percentages, parts and ratios are by weight unless indicated otherwise.

### EXAMPLES

### Example 1

### Fruit Yoghurt Comprising CLA

FORMULATION (WT %)

| | Dosage [%] | Dosage |
|---|---|---|
| Ingredient | white mass | overall [%] |
| Semi-skimmed milk 1.5% fat | 90.920 | 84.370 |
| Sugar | 4.000 | 3.710 |
| Skimmed milk powder | 1.900 | 1.76 |
| CLARINOL ™ | 1.875 | 1.74 |
| Whey protein powder (30% protein) | 1.300 | 1.21 |
| Direct starter culture | 0.005 | 0.005 |
| Strawberry puree °Brix aseptic | | 7.205 |

CLARINOL ™ is a trademark of Lipid Nutrition BV (Wormerveer, The
Netherlands) and has the following composition:

| | |
|---|---|
| Oil (as glyceride) | 80% by weight |
| Carbohydrate | 10% by weight |
| Protein | 7.5% by weight |
| Total CLA | 610 mg/g |
| c9t11 and t10c12 isomers | 570 mg/g |

A 10% pre-emulsion of CLARINOL™ in milk is made by slowly mixing in CLARINOL™ to milk of 60° C. under high-shear mixing. The mixture is homogenised dual-stage at 200/50 bar and the resulting emulsion cooled to 4° C. Dry blend sugar, milk powder and whey protein is mixed with the rest of the milk. Then the CLARINOL™ pre-emulsion is added. The milk is heated to 60° C., homogenized dual-stage at 160/40 bar and heated 2 minutes at 95° C. The milk is cooled to a fermentation temperature of 32° C. Starter culture is added to the milk at 32° C. and milk is fermented till pH 4.3-4.5. The resulting yoghurt is cooled to about 20° C., stirred and sugar syrup and fruit are added to the yoghurt. Yoghurt is filled in polypropylene beakers, sealed and cooled to 4° C.

Optionally sugar syrup and fruit can be replaced by commercial fruit preparations. Optionally 40 ppm sodium formiate can be added to the milk before heat treatment to promote growth of L. bulgaricus.

The yoghurt contains 7.205% by weight fruit.

### Example 2

### Comparison of High and Low Sugar Fruit Yoghurts

A yoghurt according to the invention was prepared using the following recipe.

Recipe low sugar
fruit yoghurt
Batch size [kg] 3.5

| | | | | | Pre- |
|---|---|---|---|---|---|
| | | Dosage | Dosage | | emulsion |
| Ingredient | Supplier | [%] | [g] | Direct | 10% |
| skimmed milk | | 87.63% | 3067.05 | 1951.95 | 1115.1 |
| skimmed milkz | Grobak | 3.40% | 119 | 119 | |
| powder | | | | | |
| gelatin | Dr Oetker | 0.37% | 12.95 | 12.95 | |
| sugar | | 4.00% | 140 | 140 | |
| Clarinol ™* | Lipid | 3.54% | 123.9 | | 123.9 |
| | Nutrition | | | | |
| fruit concentrate | | 1.00% | 35 | 35 | |
| starter culture | Danisco | 0.01% | 0.35 | 0.35 | |
| flavoring | Quest | 0.05% | 1.75 | 1.75 | |
| Total | | 100.00% | 3500 | 2261 | 1239 |

*CLA as triglyceride (Lipid nutrition B.V., Wormerveer, The Netherlands)

By way of comparison, the following example of a yoghurt having a higher sugar content was prepared.

Recipe as given in
example 2 of US
2006/0159824
Batch size [kg] 3.5

| | | | | | Pre- |
|---|---|---|---|---|---|
| | | Dosage | Dosage | | emulsion |
| Ingredient | Supplier | [%] | [g] | Direct | 10% |
| skimmed milk | | 84.63% | 2962.05 | 1846.95 | 1115.1 |
| skimmed milk | Grobak | 3.40% | 119 | 119 | |
| powder | | | | | |
| gelatin | Dr Oetker | 0.37% | 12.95 | 12.95 | |
| sugar | | 8.00% | 280 | 280 | |
| Clarinol | Lipid | 3.54% | 123.9 | | 123.9 |
| | Nutrition | | | | |
| starter culture | Dansico | 0.01% | 0.35 | 0.35 | |
| flavoring | Quest | 0.05% | 1.75 | 1.75 | |
| Total | | 100.00% | 3500 | 2261 | 1239 |

The milk was heated to 60° C. A 10% pre-emulsion of the oil in milk at 60° C. was prepared and the pre-emulsion homogenized at 200/50 bar. The skimmed milk powder, sugar, gelatine, and flavouring were dissolved in the remaining milk at 60° C. Then the pre-emulsion was added using the ultra-turrax. The product was heated for 10 minutes at 75-100° C. and homogenized at 160/40 bar. The product was cooled down to 38° C. and the starter culture (Yo-mix 883 LYO comprising lactic acid bacteria, Danisco) added to the product. Fermentation took place overnight (10-12 hours) in a climate cabinet at 38° C.

All yoghurt mixtures were extracted with chloroform and methanol following this principle: To 100 g of yoghurt mixture 10 g of KCl, 100 ml chloroform and 50 ml methanol were added, The samples were put on a turax for 3 minutes at a speed of 12000 rpm. The mixture was centrifuged for 5 min at 4500 rpm. The upper layer was removed with a pipette and the lower layer together with a white pellet, which was formed in-between the layers were transferred to a filter. The solvents present in the filtrate were evaporated and the oil dried with nitrogen over night. The oil was submitted for Rancimat and Anisidine analysis.

As comparison, the same yoghurt example, followed by the same extraction method was repeated with 3.75 g safflower oil. The Clarinol oil and safflower oil extracted from the yoghurt mixture were compared with the pure Clarinol oil and safflower oil not incorporated in a yoghurt. The results were as follows.

| | | Oil extracted from | | | | | Pure oil | | | | |
|---|---|---|---|---|---|---|---|---|---|---|---|
| | | yoghurt | | | | | not extracted | | | | |
| | | Time (days) | | | | | | | | | |
| | | 0 | 2 | 4 | 7 | 10 | 0 | 2 | 4 | 7 | 10 |
| Results | Rancimat | 1.6 | 1.9 | 1.6 | 1.5 | 0.8 | 2.1 | 2.1 | 1.9 | 1.8 | 2.2 |
| according | (AOCS | | | | | | | | | | |
| to present | Cd 12b- | | | | | | | | | | |
| invention | 92) | | | | | | | | | | |
| Results | Rancimat | 0.8 | 1 | 0.9 | 1 | 1.1 | 2.1 | 2.1 | 1.9 | 1.8 | 2.2 |
| according | (AOCS | | | | | | | | | | |
| to US 2006/ | Cd 12b- | | | | | | | | | | |
| 0159824 | 92) | | | | | | | | | | |
| Safflower | Rancimat | 1.5 | 1.6 | 1.7 | 1.6 | 1.3 | 2.9 | 2.7 | 2.7 | 2.9 | 2.9 |
| oil | (AOCS | | | | | | | | | | |
| | Cd 12b- | | | | | | | | | | |
| | 92) | | | | | | | | | | |

The results show the surprisingly improved stability of the compositions of the invention.

1. A yoghurt comprising: a fat phase comprising conjugated linoleic acid or a derivative thereof (CLA); fruit; and sugar in an amount of less than 7.5% per weight.

2. Yoghurt as claimed in claim 1, having a sugar content of less than 5% by weight.

3. Yoghurt as claimed in claim 2 which comprises non-fat milk solids in an amount of from 5 to 20% by weight.

4. Yoghurt as claimed in claim 3, wherein the fat phase comprises at least 20% by weight CLA.

5. Yoghurt as claimed in claim 1 wherein the sugar is replaced completely or partially by sugar replacers.

6. Yoghurt as claimed in claim 1, which comprises a sweetener.

7. Yoghurt as claimed in claim 6, wherein the sweetener is selected from aspartame, acesulfame, sucralose and mixtures thereof.

8. Yoghurt as claimed in claim 1 having a fruit content of at least 0.5% by weight on a wet basis.

9. Yoghurt as claimed in claim 8 having a fruit content of at least 1% by weight on a wet basis.

10. Yoghurt as claimed in claim 8 having a fruit content of from 2 to 10% by weight.

11. Yoghurt as claimed in claim 8, wherein the fruit is in the form of fruit particles, fruit puree, fruit concentrate, fruit juice or mixtures thereof.

12. Yoghurt as claimed in claim 1, which has an energy content of less than 100 kcal/100 g.

13. Yoghurt as claimed in claim 12, which has an energy content of less than 80 kcal/100 g.

14. Yoghurt as claimed in claim 1 comprising dietary fibre.

15. Yoghurt as claimed in claim 1, wherein the fat phase comprises at least 20% by weight of the c9t11 isomer of CLA.

16. Yoghurt as claimed in claim 1 wherein the fat phase comprises at least 20% by weight of the t10c12 isomer of CLA.

17. Yoghurt as claimed in claim 1, wherein the CLA is incorporated in the yoghurt in the form of a powder.

18. Yoghurt as claimed in claim 17, wherein the powder is produced by spray drying CLA, or a fat comprising CLA, with protein and/or carbohydrate.

19. Yoghurt comprising: a fat phase comprising conjugated linoleic acid or a derivative thereof (CLA); and fruit,
wherein the yoghurt has an energy content of less than 100 kcal/100 g.

20. Yoghurt as claimed in claim 19, which has an energy content of less than 80 kcal/100 g.

21. Process for producing the yoghurt of claim 1, which comprises:
(a) forming an emulsion of conjugated linoleic acid or a derivative thereof (CLA) in milk;
(b) forming a mixture of milk powder, whey protein and optionally sugar, with milk;
(c) combining the emulsion of (a) with the mixture of (b);
(d) optionally pasteurising the product of (c); and
(e) fermenting the optionally pasteurised product of (c) in the presence of a starter culture.

22. Process as claimed in claim 21, wherein the CLA is incorporated in the milk in the form of a powder.

23. Process as claimed in claim 22, wherein the powder is produced by spray drying CLA, or a fat comprising CLA, with protein and/or carbohydrate.

24. (canceled)

25. (canceled)

26. Yoghurt as claimed in claim 4 wherein the fat phase comprises from 40% to 100% by weight CLA.

27. Yoghurt as claimed in claim 10 having a fruit content of from 3.5 to 8% by weight on a wet basis.

28. Yoghurt as claimed in claim 13 which has an energy content of from 55 to 75 kcal/100 g.

29. Yoghurt as claimed in claim 20 which has an energy content of from 55 to 75 kcal/100 g.

30. Method for providing a nutritional benefit to a subject in need of same which comprises administering thereto a yoghurt according to claim 1.

31. Method according to claim 30 wherein the benefit is for body weight management.
